(19) United States
(12) Patent Application Publication
(10) Pub. No.: US 2026/0012888 A1
(43) Pub. Date: Jan. 8, 2026

(54) DETECTING END OF TRAFFIC AT A USER EQUIPMENT

(71) Applicant: Samsung Electronics Co., Ltd., Suwon-si (KR)

(72) Inventors: Anum Ali, Frisco, TX (US); Vutha Va, Plano, TX (US); Yuqiang Heng, Plano, TX (US); Boon Loong Ng, Plano, TX (US)

(21) Appl. No.: 19/009,892

(22) Filed: Jan. 3, 2025

Related U.S. Application Data
(60) Provisional application No. 63/667,379, filed on Jul. 3, 2024.

(51) Int. Cl. H04W 52/02; H04W 24/02; H04W 76/20; H04W 76/30

(52) U.S. Cl. CPC H04W 52/0229; H04W 24/02; H04W 76/20; H04W 76/30

(57) ABSTRACT

A method and device for detecting an end of data traffic at a user equipment (UE). A method performed by the UE comprises determining whether the UE is in a radio resource control (RRC) connected state. When the UE is in the RRC connected state, the method includes performing a link management procedure that includes (i) a link release condition procedure for determining whether a link release condition is satisfied and (ii) a link release procedure for releasing a link early and reducing UE power consumption. When the UE is not in the RRC connected state, the method includes not performing the link management procedure.

### CROSS-REFERENCE TO RELATED APPLICATION AND CLAIM OF PRIORITY

This application claims priority under 35 U.S.C. § 119 (e) to U.S. Provisional Patent Application No. 63/667,379 filed on Jul. 3, 2024, which is hereby incorporated by reference in its entirety.

### TECHNICAL FIELD

This disclosure relates generally to wireless communication, and more specifically to detecting an end of data traffic at a user equipment (UE).

### BACKGROUND

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

Several 5G UE power-saving techniques are investigated by 3GPP. These techniques include cross-slot scheduling, bandwidth part (BWP) adaptation, discontinuous reception (DRX), radio resource control (RRC)-inactive mode, wakeup signal (WUS), two-step RACH, UE assistance information (UAI), etc. The UAI framework introduced in Release 16 allows the 5G UE to indicate its preference on several RF parameters to the NW, and as a result, influence its power consumption. The motivation for developing these power strategies is the high-power consumption at the UE. According to several recent results from academic and industrial studies, the power consumption of the 5G modem is higher than even the power consumption of the smartphone screen.

One method to save the device power is to put the device to a lower power consumption state after some time of inactivity. Specifically, when the device is actively transmitting or receiving the data it is in the RRC_CONNECTED state. If, however, the device does not transmit/receiver for a certain period of time the network (NW) may instruct the device to go to a lower power sate. In 5G there are two such possible states. One is RRC_INACTIVE and one is RRC_IDLE. The difference between the INACTIVE and IDLE states is in what information is retained at the UE and NW related to the connection, and what level of signaling is required to transition back to the RRC_CONNECTED state. Transitioning from RRC_INACTIVE requires less signaling and hence is expected to be quicker compared to transitioning from RRC_IDLE.

The UAI feature offers an opportunity for optimizing cellular link for a class of data traffic that is bursty (e.g., like video streaming applications).

### SUMMARY

Embodiments of the present disclosure provide methods and devices for detecting an end of data traffic at a UE.

In one embodiment, a method for detecting an end of data traffic at a UE is provided. The method comprises determining whether the UE is in a radio resource control (RRC) connected state. When the UE is in the RRC connected state, the method includes performing a link management procedure that includes a link release condition procedure for determining whether a link release condition is satisfied and a link release procedure for releasing a link early and reducing UE power consumption. When the UE is not in the RRC connected state, the method includes not performing the link management procedure.

In another embodiment, a UE comprises a transceiver; and a processor operably coupled to the transceiver. The processor is configured to: determine whether the UE is in a radio resource control (RRC) connected state; when the UE is in the RRC connected state, perform a link management procedure that includes a link release condition procedure for determining whether a link release condition is satisfied and a link release procedure for releasing a link early and reducing UE power consumption; and when the UE is not in the RRC connected state, not perform the link management procedure.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit”, “receive”, and “communicate” as well as derivatives thereof, encompass both direct and indirect communication. The terms “include” and “comprise”, as well as derivatives thereof, mean inclusion without limitation. The term “or” is inclusive, meaning and/or. The phrase “associated with” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIG. 4 illustrates an example of bursty traffic for a streaming application and the potential power saving by reducing the unnecessary radio resource control (RRC) tail time after each data burst according to embodiments of the present disclosure;

FIG. 5 illustrates an example of detecting end of traffic at the UE according to embodiments of the present disclosure;

FIG. 6 illustrates an example of a fixed timer-based method to detect end of traffic according to embodiments of the present disclosure;

FIG. 7 illustrates an example of an adaptive timer-based method to detect end of traffic according to embodiments of the present disclosure;

FIG. 8 illustrates an example of an explicit method to adapt the timer according to embodiments of the present disclosure;

FIG. 9 illustrates an example of an intuitive explanation of the implicit control on the number of transitions according to embodiments of the present disclosure;

FIG. 10 illustrates an example additive method to adapt the timer according to embodiments of the present disclosure;

FIG. 11 illustrates an example multiplicative method to adapt the timer according to embodiments of the present disclosure;

FIG. 12 illustrates an example conservative method to adapt the timer according to embodiments of the present disclosure;

FIG. 13 illustrates an example trained tree from the XGBoost model according to embodiments of the present disclosure;

FIG. 14 illustrates an example online operation of the step-based ML approach according to embodiments of the present disclosure;

FIG. 15 illustrates an example online operation of the step-based ML approach with gating according to embodiments of the present disclosure;

FIG. 16 illustrates an example of features used in a burst based ML approach according to embodiments of the present disclosure;

FIG. 17 illustrates an example online operation of the burst-based ML approach according to embodiments of the present disclosure;

FIG. 18 illustrates an example data trace with TCP keep alive and TCP keep alive acknowledgement packets in data according to embodiments of the present disclosure;

FIG. 19 illustrates an example of separate handling of special packets according to embodiments of the present disclosure; and

FIG. 20 illustrates an example process for detecting an end of data traffic at the UE according to embodiments of the present disclosure.

### DETAILED DESCRIPTION

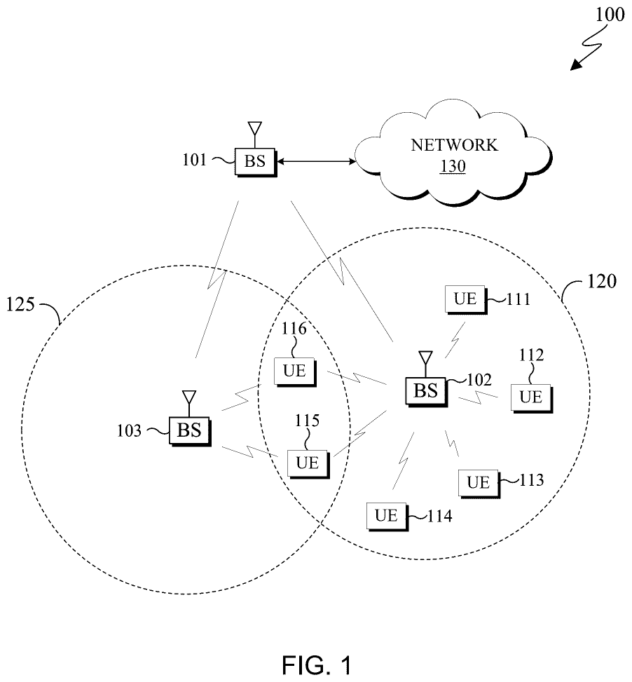

FIGS. 1 through 20, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Embodiments of the present disclosure recognize that cellular modem power consumption is a factor affecting the user experience of a mobile device as it directly impacts the battery life of the device, and that determining the end of data activity and subsequently requesting the release of the RRC connection for bursty applications running on the mobile device could positively affect power consumption.

Accordingly, various embodiments of the present disclosure can provide methods and apparatuses for detecting end of traffic at the UE. Further, various embodiments of the present disclosure can provide a fixed timer-based method of detecting end of traffic. Further, various embodiments of the present disclosure can provide a method allowing explicit control on the number of transitions using a power model for detecting end of traffic. Further still, various embodiments of the present disclosure can provide a method allowing implicit control on the number of transitions without a power model, including an additive method to adapt the timer, a multiplicative method to adapt the timer, or a conservative method to adapt the timer for detecting end of traffic. Still further, various embodiments of the present disclosure can provide a step-based machine learning (ML) approach for early RRC release. Further, various embodiments of the present disclosure can provide a burst-based ML approach for early RRC release. Still further, various embodiments of the present disclosure can provide a method for separate handling of special packets for detecting end of traffic.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station”, “subscriber station”, “remote terminal”, “wireless terminal”, “receive point”, or “user device”. For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

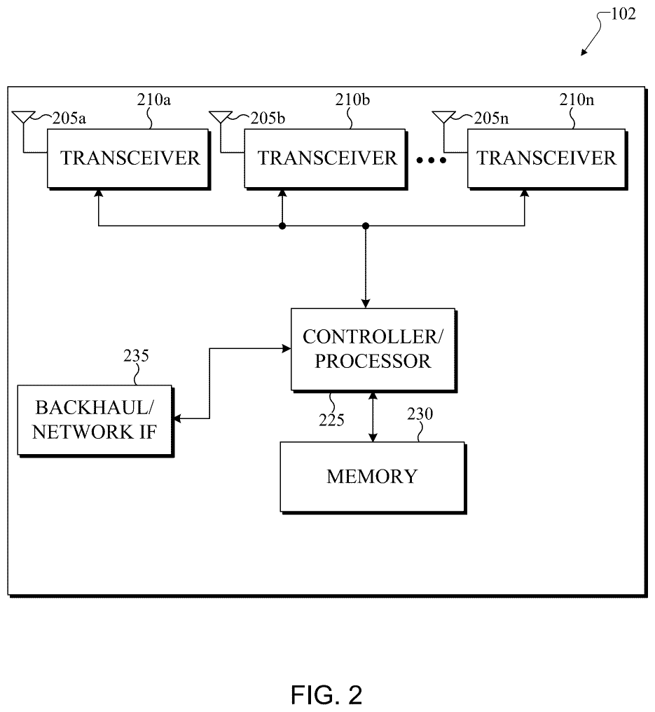

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 or the transceivers 210a-210n may include circuitry and/or programming for facilitating detecting an end of data traffic at the user equipment (UE). The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

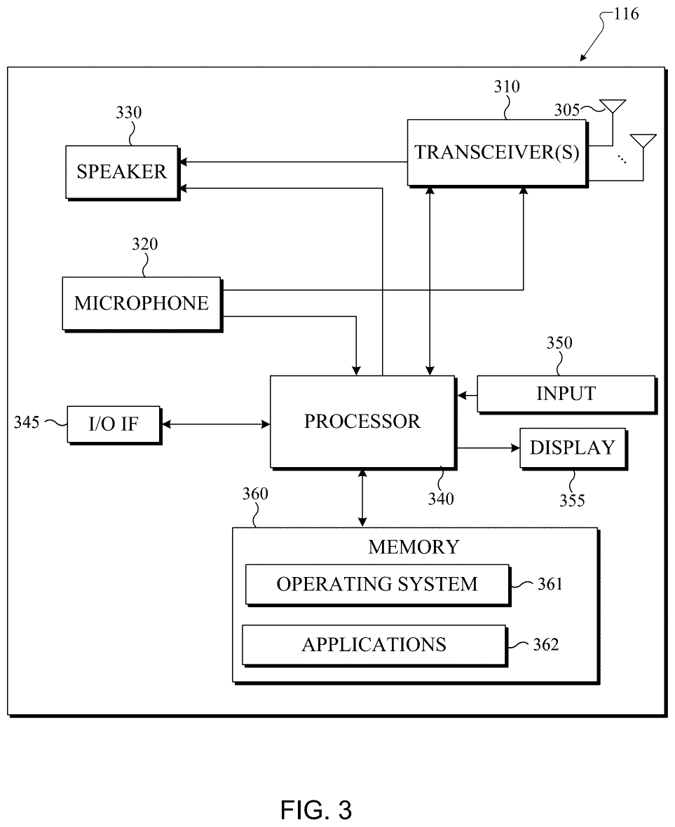

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 can include circuitry and/or programming for facilitating detecting an end of data traffic at the user equipment (UE). The processor 340 is also capable of executing other processes and programs resident in the memory 360. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

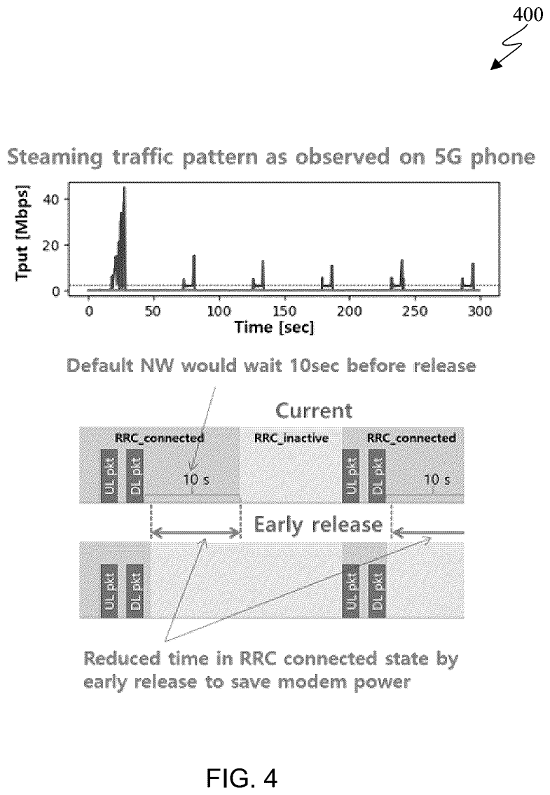

FIG. 4 illustrates an example of bursty traffic for a streaming application and the potential power saving by reducing the unnecessary RRC tail time after each data burst 400 according to embodiments of the present disclosure. The embodiment of the example of bursty traffic for a streaming application and the potential power saving by reducing the unnecessary RRC tail time after each data burst 400 illustrated in FIG. 4 is for illustration only. Other embodiments of the example of bursty traffic for a streaming application and the potential power saving by reducing the unnecessary RRC tail time after each data burst 400 could be used without departing from the scope of this disclosure.

As illustrated in FIG. 4, the UAI feature offers an opportunity for optimizing the cellular link for a class of data traffic that is bursty (e.g., streaming applications) or sporadic in nature. For this type of discontinuous data traffic, the cellular link may be set to a connected state when it is active in data communication, and the link may be set to idle with longer latency but lower power consumption during the idle time in between data bursts. Using the 3GPP terms, the connected state refers to the RRC-connected state and the idle state refers to either the RRC-Idle or RRC-inactive state as defined in the 5G specifications. However, in existing cellular systems, the management of the state of the link is left entirely to the network (NW) side. Typically, the NW would apply a generic and common rule to all UE regardless of their actual applications. For example, a commonly observed rule seen in actual data traces is that the NW would apply a simple wait time rule: if there is no data activity (both uplink and downlink) for 10 sec, the NW would release the UE's RRC connection and send it to the idle state. Given the knowledge of the traffic patterns, this approach is a too simplistic and a non-optimal solution.

The UE having knowledge of the traffic patterns running at its side can detect the data burst-end and using UAI, it can request the RRC release right after the detection which can reduce the unnecessary time in the connected state. Because the UE consumes more power in the connected state compared to the idle state, the reduction in the time duration in the connected state means lower power consumption. An illustration of this is shown in FIG. 4.

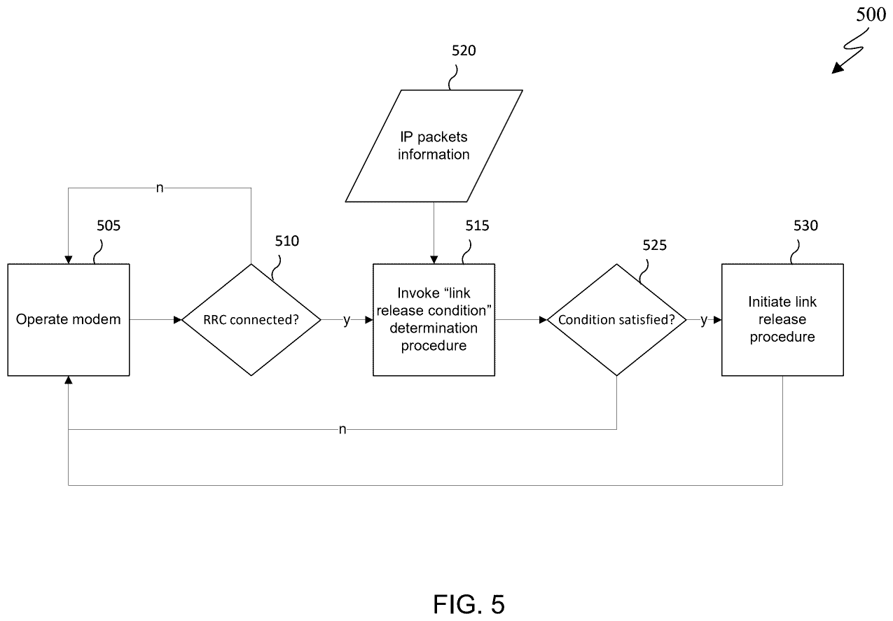

FIG. 5 illustrates an example 500 of detecting end of traffic at the UE according to embodiments of the present disclosure. The embodiment of the example 500 of detecting end of traffic at the UE illustrated in FIG. 5 is for illustration only. Other embodiments of the example 500 of detecting end of traffic at the UE could be used without departing from the scope of this disclosure.

As illustrated in FIG. 5, in one embodiment, the modem is continuously operational at 505. The operation of the modem can cover all possible RRC states, i.e., IDLE, INACTIVE, CONNECTED. At 510, a determination is made whether the device is in the RRC_CONNECTED state. If not, then the process reverts to 505 and the modem operates as is. If the device is in the RRC_CONNECTED state, then the module 515 that checks whether the condition to release the link is satisfied is invoked. Releasing the link means transitioning to a lower power state like IDLE or INACTIVE. The module 515 receives the IP packet information 520 as an input. The output of the module 515 is an indicator 525 that indicates whether the condition to release the link is satisfied or not. If the condition is satisfied, then the link release procedure is initiated 530 and the procedure reverts to 505. If the condition is not satisfied then the procedure reverts to 505 and the modem continues to operate as is.

As described above, in Release 16 of the 5G NR (Fifth Generation New Radio) specifications, a feature called UAI (UE Assistance Information) was introduced that allows the UE with the knowledge of the applications running on its side to adjust some cellular link parameters so that the user experience is maintained while saving the UE power. This feature allows the UE to convey desired link configuration that includes but is not limited to: delay budget; overheating assistant information; in-device coexistence; preferred discontinuous reception configuration; preferred maximum aggregated bandwidth; preferred maximum number of secondary control channels (CCs); preferred maximum number of MIMO layers; preferred scheduling offset and cross-slot scheduling; and preferred radio resource control (RRC) state.

Through UAI the device can convey its desired RRC state, be it IDLE or INACTIVE to the NW. Since a subset of all applications on the UE have the bursty behavior and hence a good opportunity to save power using the aforementioned solution, the disclosed solution can be activated if some application of interest is active and detected.

### Fixed Timer-Based Method:

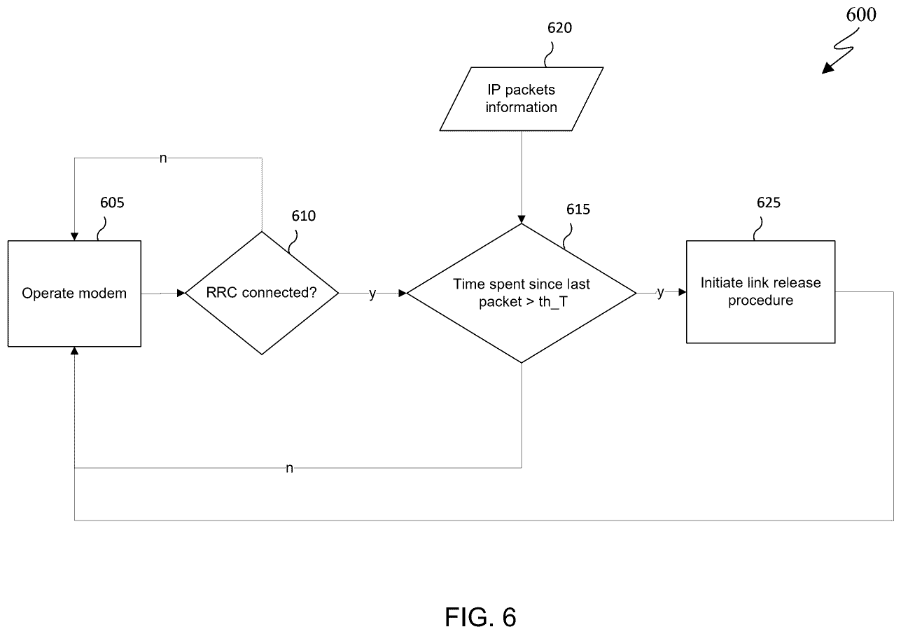

FIG. 6 illustrates an example of a fixed timer-based method 600 to detect end of traffic according to embodiments of the present disclosure. The embodiment of the example fixed timer-based method 600 to detect end of traffic illustrated in FIG. 6 is for illustration only. Other embodiments of the example fixed timer-based method 600 to detect end of traffic could be used without departing from the scope of this disclosure.

The fixed timer-based method to determine the end of traffic at the UE is shown in FIG. 6. As illustrated in FIG. 6, in one embodiment, the modem is continuously operational at 605. The operation of the modem can cover all possible RRC states, i.e., IDLE, INACTIVE, CONNECTED. At 610, a determination is made whether the device is in the RRC_CONNECTED state. If not, then the process reverts to 605 and the modem operates as is. If the device is in the RRC_CONNECTED state, then subsequently based on the IP packet information 620, a determination is made whether a predetermined time has passed since any packet is received or transmitted at 615. This timer is called th_T. If more than th_T time has passed, then the device initiates the link release procedure 625, otherwise the procedure reverts to 605 and the modem operates as is.

The timer th_T is basically an inactivity timer. On one hand, the shorter the value of th_T the more the device can remain in the lower power consumption state (i.e., RRC IDLE or INACTIVE). On the other hand, the more quickly the device goes to the lower power consumption state, the more transitions there will be between RRC_CONNECTED and low power states. These transitions may have a negative impact on both the UE and the NW. On the NW side, there is additional signaling overhead whenever the device transitions. On the UE side, the transition from the low power consumption to higher power consumption would require some preparation time which in some cases can have power consumption comparable to higher than active data transmission. Because the NW typically uses an inactivity timer of 5, 10, or 15 seconds, it makes sense to use smaller values at the UE. Example values for th_T are in the range of 100 ms up to 5 seconds.

One benefit of this method is that it is a very simple method. One drawback of this method is that it is difficult to find a fixed value of th_T that could provide a good tradeoff in a variety of situations, i.e., applications, quality of service requested (e.g., high quality video or low quality video), and NW conditions (i.e., different bandwidths and signal strengths), that impact the data consumption behavior during streaming.

### Adaptive Timer-Based Method:

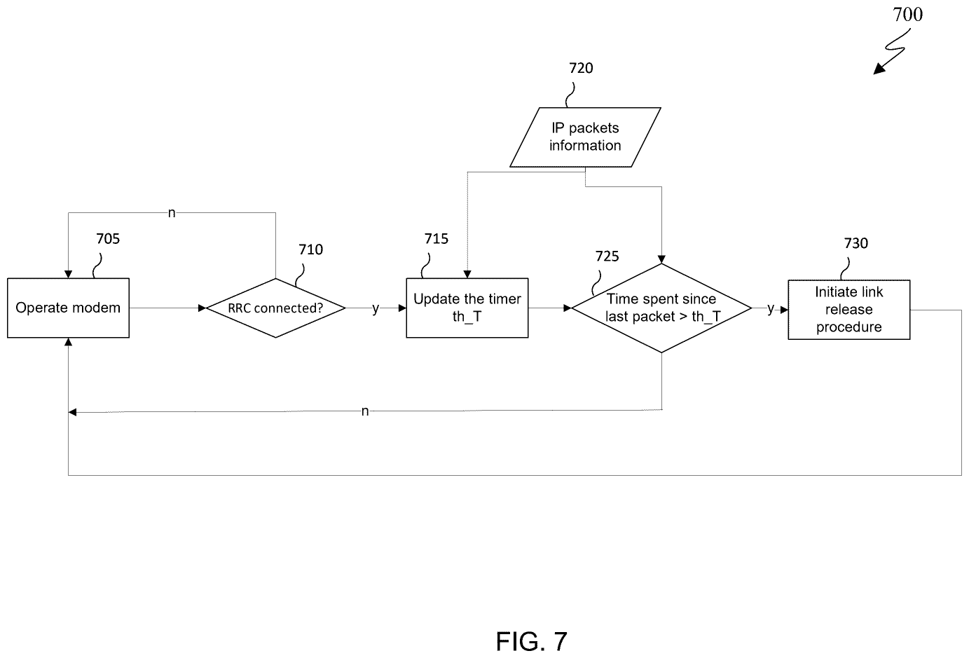

FIG. 7 illustrates an example of an adaptive timer-based method 700 to detect end of traffic according to embodiments of the present disclosure. The embodiment of the example of an adaptive timer-based method 700 to detect end of traffic illustrated in FIG. 7 is for illustration only. Other embodiments of the example of an adaptive timer-based method 700 to detect end of traffic could be used without departing from the scope of this disclosure.

In some embodiments, an adaptive timer is used instead of a fixed timer. The overview of such a strategy is shown in FIG. 7. The main difference from the fixed timer-based method is that the inactivity timer threshold is itself adapted.

As illustrated in FIG. 7, in one embodiment, the modem is continuously operational at 705. The operation of the modem can cover all possible RRC states, i.e., IDLE, INACTIVE, CONNECTED. At 710, a determination is made whether the device is in the RRC_CONNECTED state. If not, then the process reverts to 705 and the modem operates as is. If the device is in the RRC_CONNECTED state, then subsequently based on the IP packet information 720, a timer th_T is updated 715, and a determination is made whether a predetermined time has passed since any packet is received or transmitted 725. If more than th_T time has passed, then the device initiates the link release procedure 730, otherwise the procedure reverts to 705 and the modem operates as is.

As described above, the timer th_T is basically an inactivity timer. On one hand, the shorter the value of th_T the more the device can remain in the lower power consumption state (i.e., RRC IDLE or INACTIVE). On the other hand, the more quickly the device goes to the lower power consumption state, the more transitions there will be between RRC_CONNECTED and low power states. These transitions may have a negative impact on both the UE and the NW as described above with reference to the fixed timer based method.

### Explicit Control on the Number of Transitions:

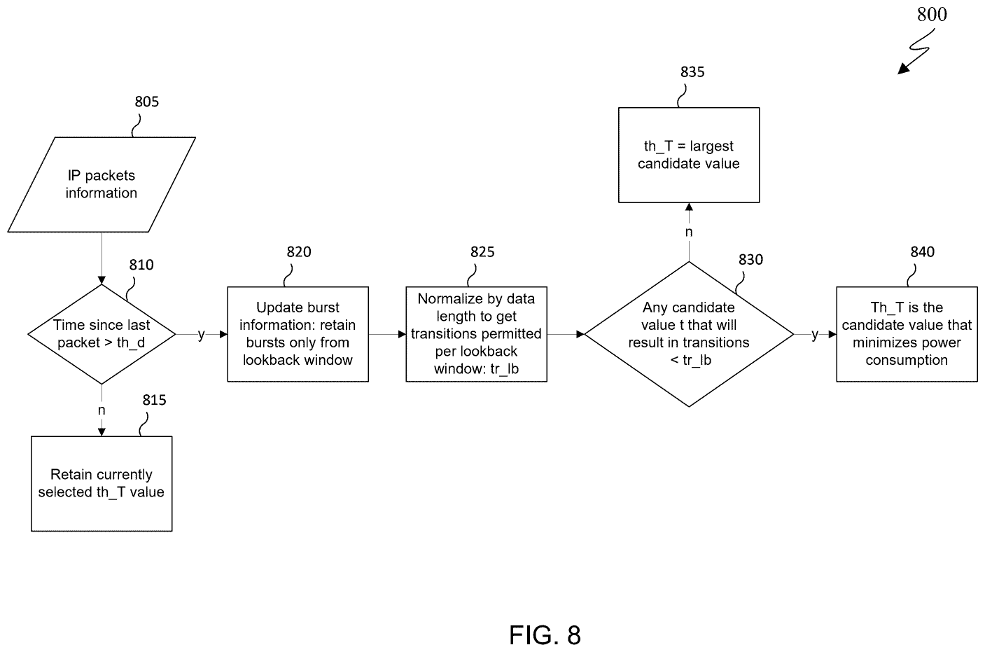

FIG. 8 illustrates an example of an explicit method 800 to adapt the timer according to embodiments of the present disclosure. The embodiment of the example of an explicit method 800 to adapt the timer illustrated in FIG. 8 is for illustration only. Other embodiments of the example of an explicit method 800 to adapt the timer could be used without departing from the scope of this disclosure.

As illustrated in FIG. 8, the method 800 takes the targeted number of transitions as an input and uses that to find a threshold th_T that can provide a number of transitions less than the maximum desired level. The information from the IP packets 805 is used to determine an end of any data activity. This is determined by checking if the time since the last packet is >th_d 810. Example values of th_d are from 0.1 to 0.5 seconds—but is generally less than th_T. If enough time has not passed, then this implies ongoing activity for which the value of th_T is not updated, and instead a currently chosen value is returned 815. If, however, sufficient time has passed, then it can be considered an end of data activity, or what is called a burst, and the link release procedure can be initiated. Since the end of the data activity also implies a new data burst has been detected, the burst information is updated 820. The burst information can be retained over a certain lookback window, i.e., as new burst information is added, older burst information (i.e., older than the lookback window) is discarded. Example values of the lookback window are in the range of 15 to 60 seconds. The reason to have a finite lookback window is to be able to adapt to varying traffic characteristics. The step of normalization 825 is used to adjust for the varying total length of the burst data currently.

Even though bursts are retained from the lookback window, the time difference between the recent most burst and the oldest burst within the lookback window is not exactly equal to the lookback window. As an example, consider a lookback window of 30 seconds. Now consider the burst start times of [0, 29, 33, 45]. In this case the latest burst is at 45 seconds. When the information of the bursts within the lookback window will be retained, the burst at 0 will be dropped. From the remaining three bursts, the total duration they represent is 45−29=16 seconds. If the expected number of transitions are calculated based on this data, without normalizing for the fact that input maximum number of transitions are assuming 30 seconds lookback window, the obtained timer will not give the desired result. A simple normalization is just to scale based on the data duration and the duration of the lookback window. If it is desired to have tr_lb_1 transitions per lookback window (lbw), then based on the data length (dl), the transitions expected from the data are tr_lb=dl/lbw*tr_lb_1. Example values of tr_lb_1 are from 5 to 20. This number may also change with how loaded the NW is, with a smaller value preferable if the cell load is high. After tr_lb is obtained, a determination of whether some candidate value of the timer satisfies the requirement on the transitions is made 830. One example set of candidate values is {0.1, 0.2, . . . , 5} seconds.

One way to check whether a candidate value will satisfy the transition constraint is to assume that the data in the lookback window is representative of the future. If a timer value implies a certain number of transitions on the recent most past data, then it can be assumed that the same number of transitions will be incurred if the timer is used in the future. If there is no candidate value that satisfies the constraint, then the largest candidate value may be chosen as the chosen threshold th_T 835 If, however, there are some candidate values that satisfy this constraint, the power consumption can be calculated for each timer value. The power calculation may also be based on the past observations under the assumption that data in the near future will have similar statistics of inter activity times. This calculation requires a power model, e.g., power consumed in IDLE state, in the CONNECTED state while transmitting data, in the CONNECTED state after the data activity has ended, and the promotion power (i.e., the power used to transition from IDLE/INACTIVE to CONNECTED). Given the past data observations and the power model the power consumption with each candidate value can be calculated. Subsequently, the candidate value that gives the smallest power consumption is chosen 840. This way, effectively, a timer can be chosen that provides transitions smaller than or equal to the maximum transition level while minimizing the power consumption of the device.

One benefit of this method is explicit design to control the number of transitions, i.e., a desired number of transitions can be fed directly as a parameter to the method. One drawback of this method is that this method requires the power model.

One alternative implementation in absence of the power model is to choose the smallest candidate value that can satisfy the constraint on the number of transitions. The smaller values generally result in a larger number of transitions and more power savings. So, the smallest value that satisfies the constraint is the value that provides maximum power savings while meeting the constraint. This approximate method will perform well as long as the promotion power (i.e., power consumed while transitioning from IDLE/INACTIVE to CONNECTED) is small. If, however, the promotion power is large, this approximate method may not work well.

### Implicit Control on the Number of Transitions:

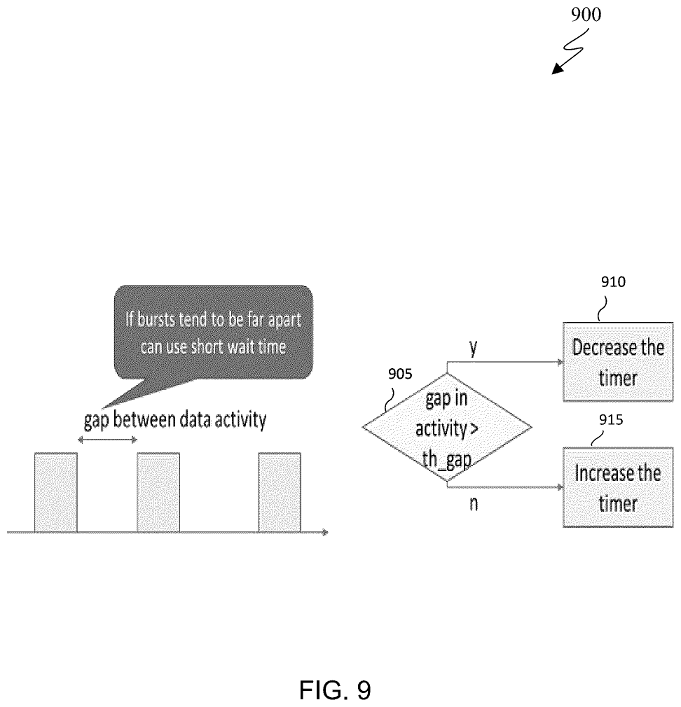

FIG. 9 illustrates an example 900 of an intuitive explanation of the implicit control on the number of transitions according to embodiments of the present disclosure. The embodiment of the example 900 of an intuitive explanation of the implicit control on the number of transitions illustrated in FIG. 9 is for illustration only. Other embodiments of the example 900 of an intuitive explanation of the implicit control on the number of transitions could be used without departing from the scope of this disclosure.

As illustrated in FIG. 9, a determination is made about the gap in activity 905. When the gap between the bursts of the data is large, then the timer value can be decreased 910, and when the gap between the bursts is small, then the timer value can be increased 915. To understand this, consider a type of data in which the bursts are quite frequent. In this case even if the UE transitions to a lower power consumption mode, it is not fruitful since the device will need to transition to RRC_CONNECTED soon. This will result in little power saving and a lot of transitions. Depending on the promotion power consumption there may even be a penalty in terms of power with rapid transitions. As such a larger value of the timer is used to avoid this kind of transition. If, however, the bursts are infrequent, then the UE can go to sleep as early as possible to maximize power savings. The high transition problem is implicitly taken care of by the infrequent nature of the bursts. This implicit control can be achieved in various ways discussed below.

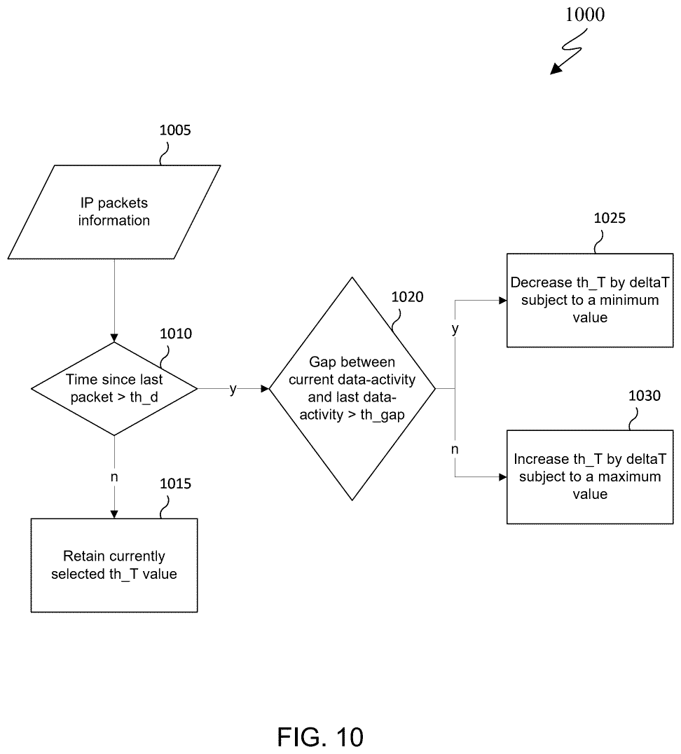

FIG. 10 illustrates an example additive method 1000 to adapt the timer according to embodiments of the present disclosure. The embodiment of the example additive method 1000 to adapt the timer illustrated in FIG. 10 is for illustration only. Other embodiments of the example additive method 1000 to adapt the timer could be used without departing from the scope of this disclosure.

Additive method: In one implementation, as illustrated in FIG. 10, the timer is increased/decreased in an additive manner. As illustrated in FIG. 10, the information from the IP packets 1005 is used to determine an end of any data activity. This is accomplished by determining whether a sufficient amount of time has passed since data activity, i.e., indicating a burst end 1010. If this is not the case, the timer is not modified and the current value of the timer th_T is retained 1015. After the burst end is determined, it is determined whether the gap between current data activity and last data activity is larger than a predetermined threshold th_gap 1020. If the gap is larger, then deltaT seconds is subtracted from th_T 1025. If the gap is smaller, then deltaT seconds is added to th_T 1030. The addition and subtraction is subject to a minimum and maximum range to avoid an unreasonable value of the timer. An example minimum value can be 0.1 seconds, and an example maximum value can be 5 seconds. If a larger value of th_gap is used then the timer th_T is likely to assume larger values as the time goes on. The reason is that the gap between two data activities will be less likely to be larger than th_gap, and as a result the timer will be increased. Similarly, if a smaller value is used the timer th_T is likely to assume smaller values as the time goes on. Example values of th_gap are in the range 0.5 to 5 seconds. An example value of deltaT is 0.1.

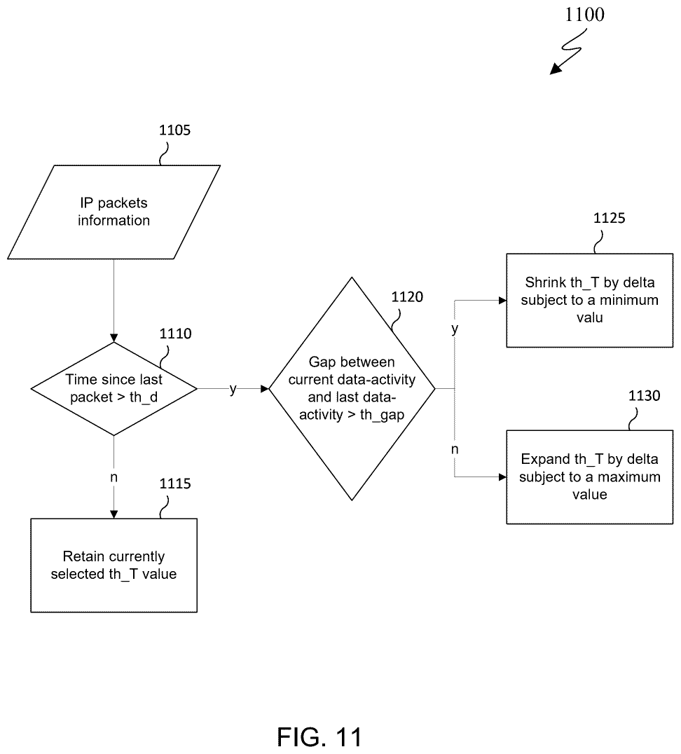

FIG. 11 illustrates an example multiplicative method 1100 to adapt the timer according to embodiments of the present disclosure. The embodiment of the example multiplicative method 1100 to adapt the timer illustrated in FIG. 11 is for illustration only. Other embodiments of the example multiplicative method 1100 to adapt the timer could be used without departing from the scope of this disclosure.

Multiplicative method: In one implementation, as illustrated in FIG. 11, the timer is increased/decreased in a multiplicative manner. In this method the time is multiplied or divided by a parameter delta. As illustrated in FIG. 11, the information from the IP packets 1105 is used to determine an end of any data activity. This is accomplished by determining whether a sufficient amount of time has passed since data activity, i.e., indicating a burst end 1110. If this is not the case, the timer is not modified and the current value of the timer th_T is retained 1115. After the burst end is determined, it is determined whether the gap between current data activity and last data activity is larger than a predetermined threshold th_gap 1120. If the gap is larger, then the value of the timer th_T is decreased by multiplying the value of the timer th_T by the parameter delta 1125. If the gap is smaller, then the value of the timer th_T is increased by dividing the value of the timer th_T by the parameter delta 1130. The parameter delta is unitless and example values can be in the 0.5 to 0.9 range. Compared to the additive adaptation method described above, the multiplicative method can impact the timer more rapidly.

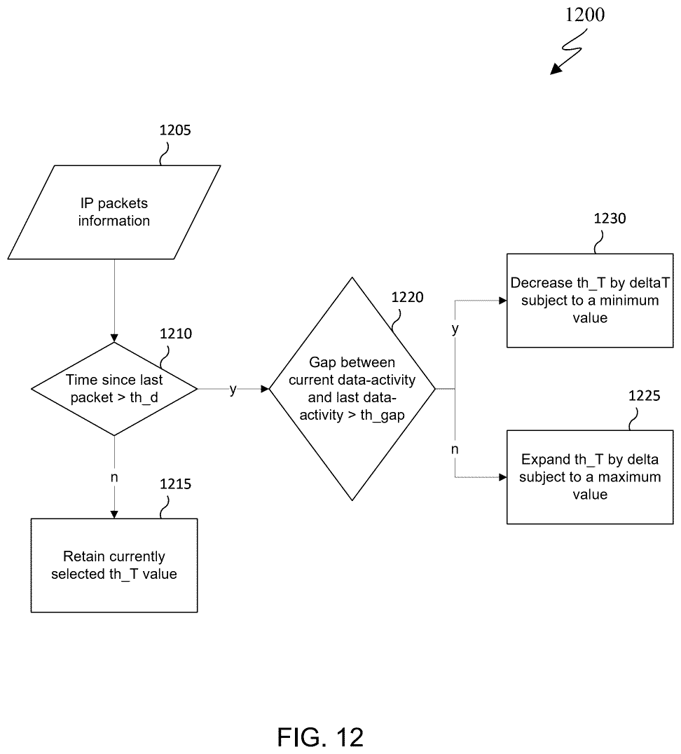

FIG. 12 illustrates an example conservative method 1200 to adapt the timer according to embodiments of the present disclosure. The embodiment of the example conservative method 1200 to adapt the timer illustrated in FIG. 12 is for illustration only. Other embodiments of the example conservative method 1200 to adapt the timer could be used without departing from the scope of this disclosure.

Conservative method: In yet another implementation, as illustrated in FIG. 12, the timer is increased/decreased in a conservative manner. In this method, the time is decreased by subtracting a parameter deltaT from the timer value and the time is increased by dividing the timer value by deltaT. This implementation is a conservative choice in terms of the number of transitions incurred.

As illustrated in FIG. 12, the information from the IP packets 1205 is used to determine an end of any data activity. This is accomplished by determining whether a sufficient amount of time has passed since data activity, i.e., indicating a burst end 1210. If this is not the case, the timer is not modified and the current value of the timer th_T is retained 1215. After the burst end is determined, it is determined whether the gap between current data activity and last data activity is larger than a predetermined threshold th_gap 1220. If the gap is larger, then the value of the timer th_T is decreased by subtracting a parameter deltaT from the timer value 1225. If the gap is smaller, then the value of the timer th_T is increased by dividing the value of the timer th_T by the parameter deltaT 1230. The parameter deltaT is unitless.

Since the timer is increased by division and decreased by subtraction, generally speaking, it is expected that the impact of several data bursts with large gaps can be offset by few data activity instances with a small gap. As such the timer is likely to retain relatively large values resulting in fewer transitions. The exact behavior, however, will be dependent on the choices of the parameters th_gap, deltaT, and delta.

### Step-Based ML Approach:

In some embodiments, an ML approach is used. The objective of an ML approach is to take some features of the IP traffic data and predict whether some data is likely in the next T seconds. The longer the period T is the harder it will become to predict, but prediction over a longer horizon also implies fewer transitions. As an example, note that if transition occurs when no data is predicted for the next 2 seconds compared to transitioning if no data is predicted for the next 0.5 second. In this instance, assuming perfect prediction, any data arriving between 0.5 to 2 seconds will result in a release of the RRC connection if predicted for the first 0.5 seconds, but will not result in a release of the RRC connection if predicted for the next 2 seconds.

One strategy can be to take a step-based approach as described below.

Offline training: The ML model can be trained on the UL and DL data activity. The total amount of the UL and DL data in mbps in a fixed interval can be taken. An example interval value is 0.5 seconds. Let us call this sum feature at time t sₜ. Then the N dimensional feature vector at time t used for prediction is sₜ=[s_{t-N+1}, . . . , sₜ₋₁, sₜ], where an example value of N is 60. The label at time t lₜ is a binary indicator on whether there is data in the next T seconds or not. Here T is a fixed value, and example values are in the range 0.5 to 2.

In principle any classifier can be trained for the prediction, including support vector machine (SVM), k nearest neighbors (KNN), convolutional neural networks (CNNs), and logistic regression, etc. The present disclosure uses XGBoost as a classifier due to its low complexity and good performance. XGBoost works by combining a number of weak learners (in the case of XGBoost—trees) to form a strong learner. During the training of XGBoost, a new tree is added—in every iteration—that predicts the residuals or errors of previously added trees. The prediction of the newly added tree is then combined with the previous trees to make the final prediction.

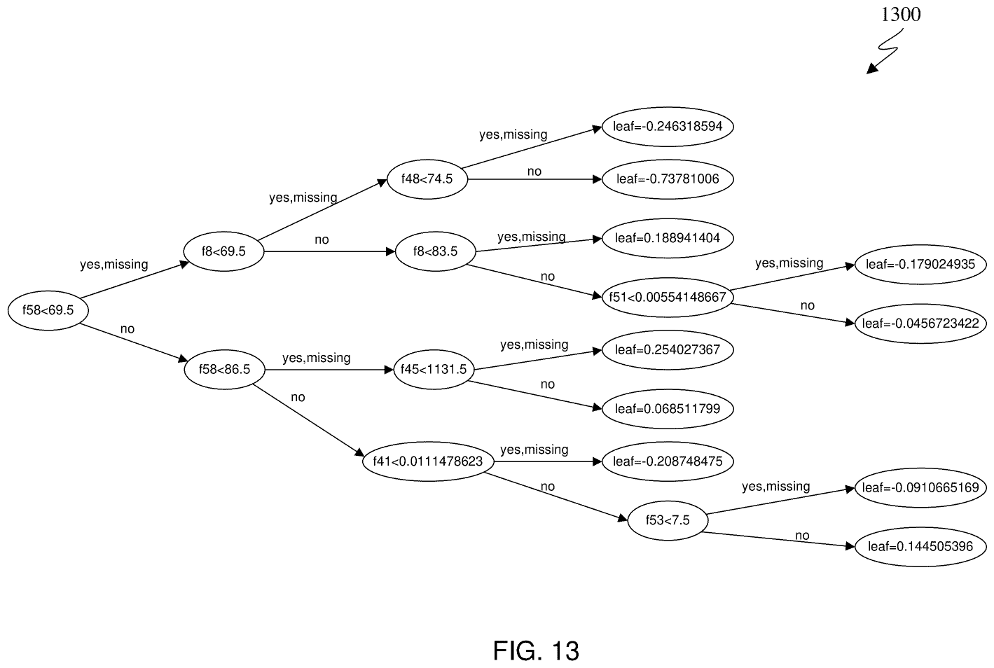

FIG. 13 illustrates an example trained tree from the XGBoost model 1300 according to embodiments of the present disclosure. The embodiment of the example trained tree from the XGBoost model 1300 illustrated in FIG. 13 is for illustration only. Other embodiments of the example trained tree from the XGBoost model 1300 could be used without departing from the scope of this disclosure.

An example tree with N=60 features is shown in FIG. 13. The decision tree starts by checking if the 58th features is less than 69.5. The value 69.5 is learned by the model. If the value is greater than 69.5, then the model checks if it is less than 86.5. If, however, the value is less than 69.5 or the value is missing, the tree checks if the 8th feature is less than 69.5. The decision making continues until one reaches a leaf. The leaf and the value of the leaf can be understood better in the context of binary classification. For a classification tree with 2 classes {0, 1}, the value of the leaf node represents the raw score for class 1. It can be converted to a probability score by using the logistic function.

The key hyperparameters of the XGBoost model are the number of trees, the maximum tree depth and the learning rate. The good or near optimal hyper parameters are found empirically, i.e., by testing a variety of parameters and using the parameters that give the best performance as the final choice.

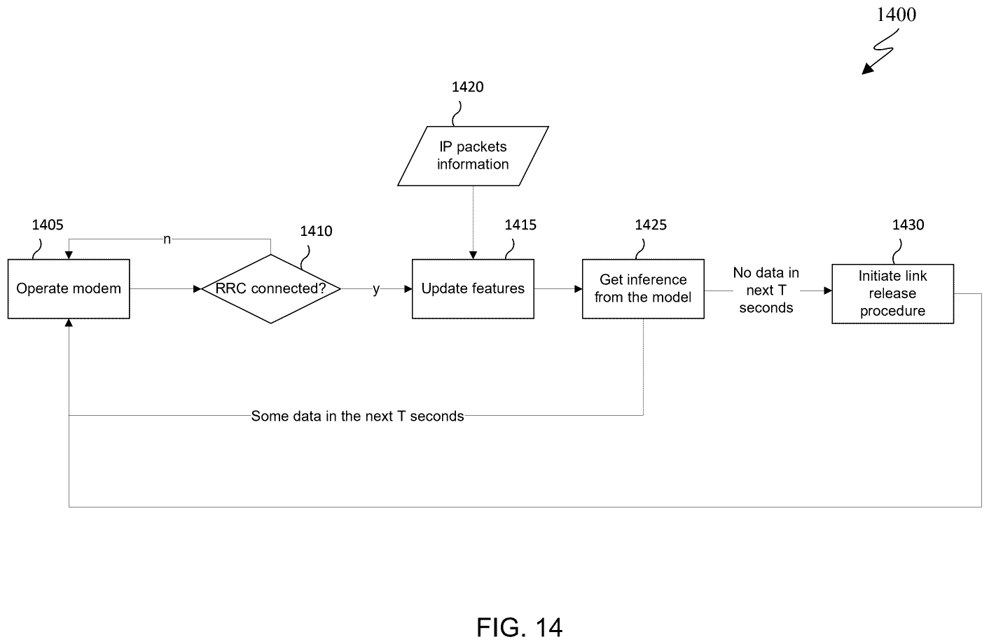

FIG. 14 illustrates an example online operation of the step-based ML approach 1400 according to embodiments of the present disclosure. The embodiment of the example online operation of the step-based ML approach 1400 illustrated in FIG. 14 is for illustration only. Other embodiments of the example online operation of the step-based ML approach 1400 could be used without departing from the scope of this disclosure.

Online operation: The online operation of the step-based ML approach is shown in FIG. 14. As illustrated in FIG. 14, in one embodiment, the modem is continuously operational at 1405. The operation of the modem can cover all possible RRC states, i.e., IDLE, INACTIVE, CONNECTED. At 1410, a determination is made whether the device is in the RRC_CONNECTED state. If not, then the process reverts to 1405 and the modem operates as is. If the device is in the RRC_CONNECTED state, then subsequently based on the IP packet information 1420, the feature sₜ are updated 1415. The feature update represents calculating all sₜ₋ᵢ to get sₜ. One example is the case when the device has just transitioned from IDLE/INACTIVE, and the features have not been updated in a while. After features are updated, an inference is obtained from the ML model 1425. If the prediction is that there is no data in the next T seconds, then the device can initiate the link release procedure 1430. If, however, the prediction is that there is some data in the next T seconds, then the procedure reverts to 1405 and the modem operates as usual.

The choice of the interval over which the UL and DL data is aggregated presents a tradeoff in complexity and accuracy. Specifically, if a shorter interval is used, e.g., 0.1 seconds, then the information is captured at a higher granularity. There, however, will be more intervals per unit of time which can result in increased complexity of the classifier. A larger interval can result in coarser granularity, and less intervals per unit of time. Specifically, if a decision is made that data from the past 30 seconds be used for classification, then an interval length of 0.1 implies a feature vector of length 300. Using an interval length of 0.5, however, will result in a feature vector of length 60. It can be argued that the classification accuracy can be higher with 0.1 seconds interval, at the expense of complexity. This complexity comes from training a bigger model and running inferences more frequently. Particularly if an inference is made after every update to the feature vector, then with 0.1 seconds interval 10 inferences per second may be needed, compared to 2 inferences per second with 0.5 seconds interval. This motivates the need to reduce the inference complexity.

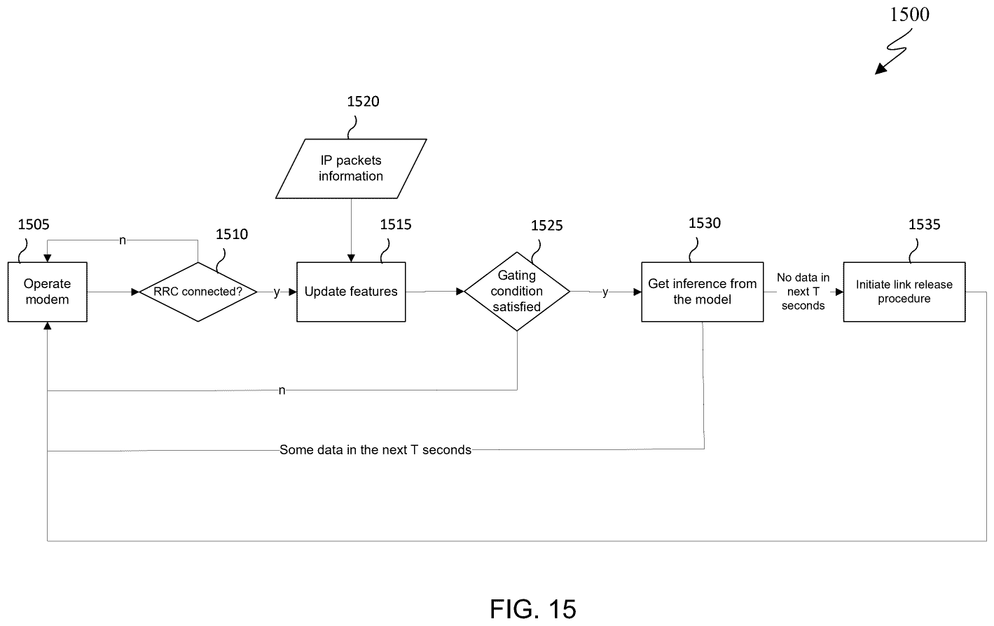

FIG. 15 illustrates an example online operation of the step-based ML approach with gating 1500 according to embodiments of the present disclosure. The embodiment of the example online operation of the step-based ML approach with gating 1500 illustrated in FIG. 15 is for illustration only. Other embodiments of the example online operation of the step-based ML approach with gating 1500 could be used without departing from the scope of this disclosure.

Gating mechanisms can be used to reduce the computational burden of running the aforementioned solution. An example of a gating based implementation is shown in FIG. 15.

As illustrated in FIG. 15, in one embodiment, the modem is continuously operational at 1505. The operation of the modem can cover all possible RRC states, i.e., IDLE, INACTIVE, CONNECTED. At 1510, a determination is made whether the device is in the RRC_CONNECTED state. If not, then the process reverts to 1505 and the modem operates as is. If the device is in the RRC_CONNECTED state, then subsequently based on the IP packet information 1520, the feature sₜ is updated 1515. The feature update represents calculating all sₜ₋ᵢ to get sₜ. One example is the case when the device has just transitioned from IDLE/INACTIVE, and the features have not been updated in a while. After features are updated, it is determined whether the gating condition is satisfied or not 1525. An example gating mechanism is to check if the last feature is 0. If the gating condition is not satisfied, then the procedure reverts to 1505 and the modem operates as usual. If the gating condition is satisfied, then an inference is obtained from the ML model 1530 The last feature being 0 is an indication that data activity is decreasing. With this gating mechanism fewer inferences are made and computational burden is reduced.

In general, the ML based strategies can learn some patterns in the data and may perform better than the timer-based approaches. This, however, comes at the cost of computational complexity. In addition, and offline training phase is need for supervised ML based strategies, whereas for timer-based methods prior data-collection is not necessary. Specific to the step-based ML method, one benefit of this ML based method is that the feature calculation is simple, but one drawback is that the burst-based information may not be captured precisely. Particularly, if mid to large interval size is used, then it will not be clear where exactly the data activity has ended inside the interval.

Note that in the problem of early RRC release, after an inference is made by the ML model on whether there is data or not in the next T seconds, there will be immediate feedback on whether this decision is correct or not. As such in another implementation, this feedback is used in a reinforcement learning framework to improve the performance of the model and make it adapt to varying traffic and data characteristics. In addition to better adaptation, the reinforcement learning approach may not need offline data training.

Burst-based ML approach, in another ML approach, burst-based information instead of step-based information can be used.

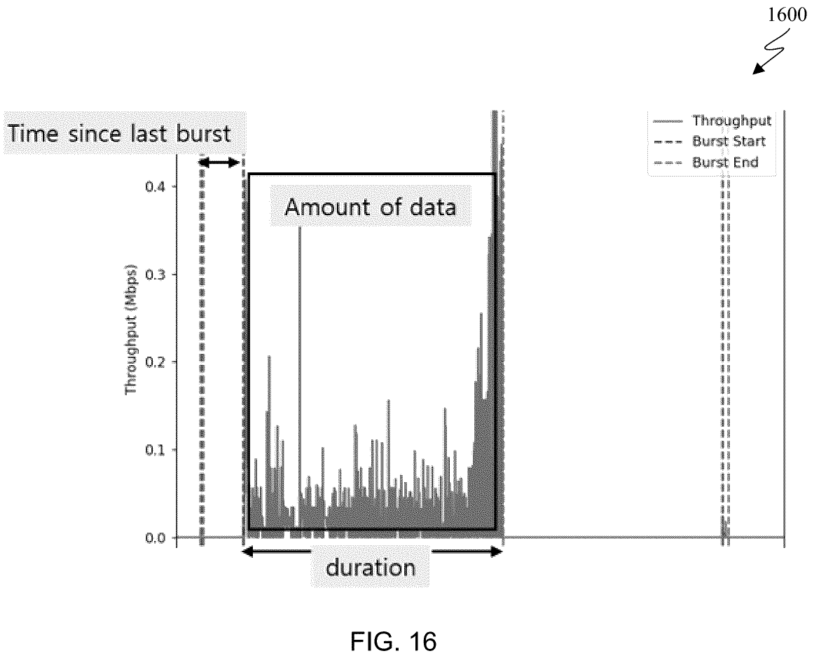

FIG. 16 illustrates an example of features used in a burst based ML approach 1600 according to embodiments of the present disclosure. The embodiment of the example of features used in a burst based ML approach 1600 illustrated in FIG. 16 is for illustration only. Other embodiments of the example of features used in a burst based ML approach 1600 could be used without departing from the scope of this disclosure.

Offline training: The features used for the training are intuitively shown in FIG. 16. Specifically, for each data-activity, the end of burst is determined. The end of burst determination can be made by waiting a period th_d since the last packet. If t represents current time then t-th_d would represent the burst end time, bₑ_{ᵢ}, i.e., the burst end of the ith burst. The difference between the burst end time and burst start time provides the burst duration, i.e., b_{d}_{ᵢ}. The time difference between the end of the last burst and the start of the current burst is also noted and is referred to as bₗ_{ᵢ}. Then the feature vector is constructed from the last N bursts information and is given as bₜ=[bₑ_{_{i−N+1}}, b_{d}_{_{i−N+1}}, bₗ_{_{i−N+1}}, . . . bₑ_{_{i−1}}, b_{d}_{_{i−1}}, bₗ_{_{i−1}}, bₑ_{ᵢ}, b_{d}_{ᵢ}, bₗ_{ᵢ}]. An example value of N is 5. The label at time current time t lₜ is a binary indicator on whether there is data in the next T seconds or not. Here T is a fixed value, and example values are in the range 0.5 to 2. For the training of the burst-based ML approach, XGBoost can be used due to its lower computational complexity and good performance.

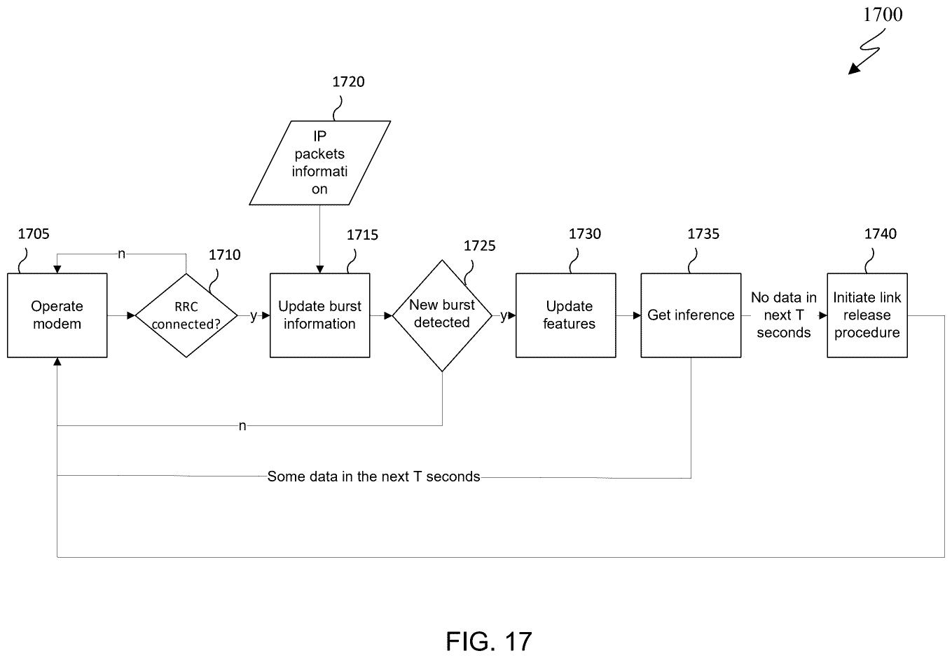

FIG. 17 illustrates an example online operation of the burst based ML approach 1700 according to embodiments of the present disclosure. The embodiment of the online operation of the burst based ML approach 1700 illustrated in FIG. 17 is for illustration only. Other embodiments of the online operation of the burst based ML approach 1700 could be used without departing from the scope of this disclosure.

As illustrated in FIG. 17, in one embodiment, the modem is continuously operational at 1705. The operation of the modem can cover all possible RRC states, i.e., IDLE, INACTIVE, CONNECTED. At 1710, a determination is made whether the device is in the RRC_CONNECTED state. If not, then the process reverts to 1705 and the modem operates as is. If the device is in the RRC_CONNECTED state, then subsequently based on the IP packet information 1720, burst data is updated 1715. A determination is made whether a new burst is detected at 1725. If a new burst is not detected then the process reverts to 1705 and the modem operates as is. If a new burst is detected then the burst features are updated 1730 and an inference is obtained 1735 which determines whether the modem operation continues as is or the link release procedure is initiated 1735. Note that in the burst-based ML approach the inference is made whenever a new burst is detected, so there is implicit gating which prevents running unnecessary inferences.

One benefit of the burst-based ML approach is that it captures the timing information of data-activity more precisely. One drawback is that the feature calculation is slightly more involved than the step-based method, but the feature calculation may not pose too much computational burden.

### Separate Handling of Special Packets:

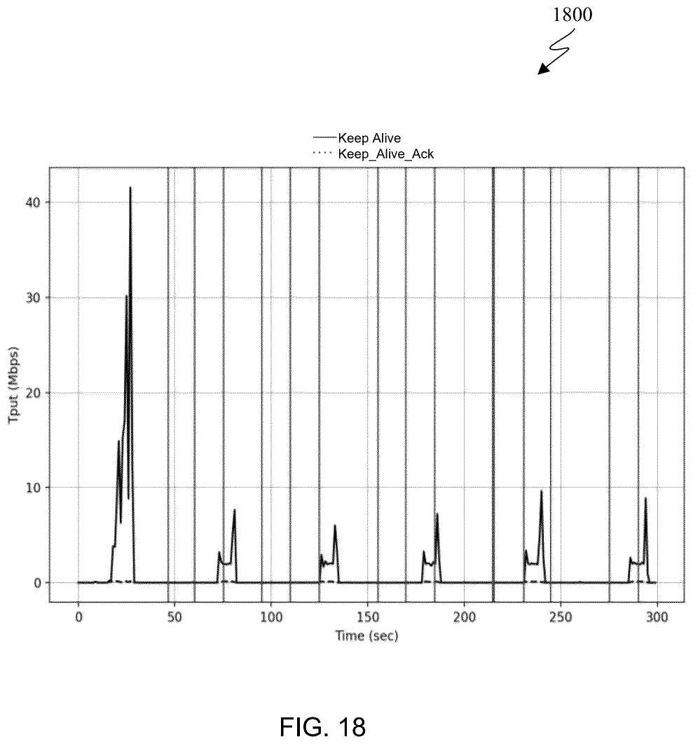

FIG. 18 illustrates an example data trace with TCP keep alive and TCP keep alive acknowledgement packets in data 1800 according to embodiments of the present disclosure. The embodiment of the example data trace with TCP keep alive and TCP keep alive acknowledgement packets in data 1800 illustrated in FIG. 18 is for illustration only. Other embodiments of the example data trace with TCP keep alive and TCP keep alive acknowledgement packets in data 1800 could be used without departing from the scope of this disclosure.

In some cases, the UE transitions to RRC_CONNECTED for special packets. One special packet type is TCP keep alive (KA) and TCP keep alive acknowledgement (KAA). The packet is sent to keep the TCP connection between the two devices alive. This can be used when it is expected that there are large gaps between the data activity. But the presence of TCP KA and KAA packets implies that the device will need to transition to RRC_CONNECTED for these packets. An example data trace with TCP KA and KAA packets are shown in FIG. 18. Note that there are TCP KA and KAA packets sometimes even in the duration when there is no data. TCP KA and KAA are examples of special packets. Other types of special packets include but are not limited to TCP FIN and FIN ACK, RESET, DNS packets etc. Also, from the perspective of maintaining QoS while ensuring as much power saving as possible, all packets coming from applications other than the foreground application can also be considered special packets.

Some of the methods discussed above may lead to unnecessary power consumption in the presence of special packets. As an example, when a fixed timer is used, e.g., with the value 2 seconds, then the device will need to stay in RRC_CONNECTED for 2 seconds in cases when the device transitioned to RRC_CONNECTED for transmission/reception of special packets. This problem can be circumvented by separate handling of the special packets compared to other situations.

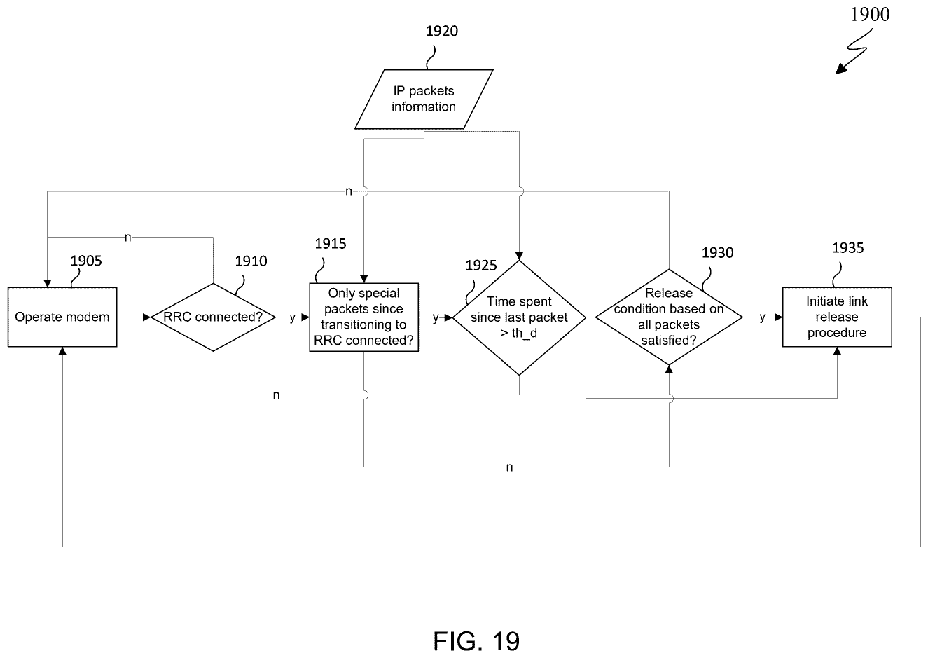

FIG. 19 illustrates an example of separate handling of special packets 1900 according to embodiments of the present disclosure. The embodiment of the example of separate handling of special packets 1900 illustrated in FIG. 19 is for illustration only. Other embodiments of the example of separate handling of special packets 1900 could be used without departing from the scope of this disclosure.

As illustrated in FIG. 19, in one embodiment, the modem is continuously operational at 1905. The operation of the modem can cover all possible RRC states, i.e., IDLE, INACTIVE, CONNECTED. At 1910, a determination is made whether the device is in the RRC_CONNECTED state. If not, then the process reverts to 1905 and the modem operates as is. If the device is in the RRC_CONNECTED state, then subsequently based on the IP packet information 1920, the UE checks if there are just special packets since the device has transitioned to the RRC_CONNECTED state 1915. If there are packets other than the special packets, then the early RRC release procedures discussed so far herein (i.e., fixed timer based, adaptive timer based, and ML based) can be used, and a determination is made whether a release condition based on all packets has been satisfied 1930. If the release condition is satisfied, then the device initiates the link release procedure 1935, otherwise the procedure reverts to 1905 and the modem operates as is. If, however, there are just special packets, then a determination is made whether a predetermined time has passed since any packet is received or transmitted 1925. If more than th_T time has passed, then the device initiates the link release procedure 1935, otherwise the procedure reverts to 1905 and the modem operates as is. Note that the timer th_d is a much smaller value, e.g., 0.1 seconds, and as such guarantees quick RRC connection release in case the device transitions to RRC_CONNECTED just for special packets.

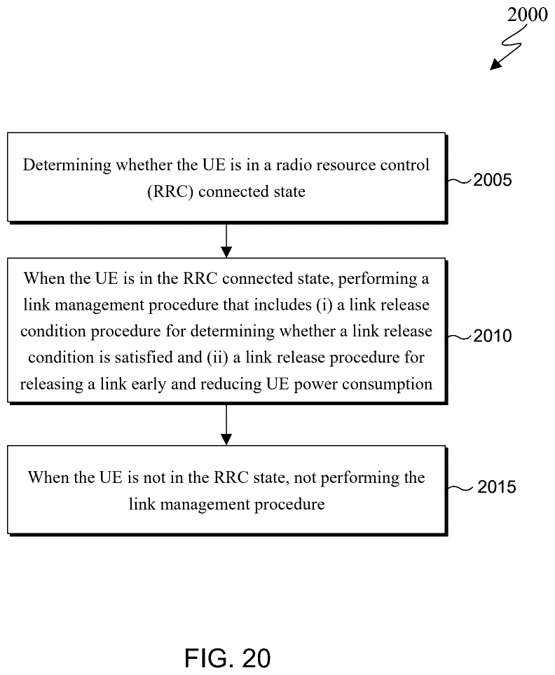

FIG. 20 illustrates an example method 2000 performed by a UE for detecting an end of data traffic at the UE according to embodiments of the present disclosure. The embodiment of a method 2000 for detecting an end of data traffic at the UE shown in FIG. 20 is for illustration only. Other embodiments of a method 2000 for detecting an end of data traffic at the UE could be used without departing from the scope of this disclosure.

As illustrated in FIG. 20, the method 2000 begins at step 2005, where the UE determines whether the UE is in an RRC connected state. At step 2010, when the UE is in the RRC connected state, the UE performs a link management procedure that includes (i) a link release condition procedure for determining whether a link release condition is satisfied and (ii) a link release procedure for releasing a link early and reducing UE power consumption. At step 2015, when the UE is not in the RRC connected state, the UE does not perform the link management procedure.

In one embodiment, the UE performs the link release condition procedure for determining, based on received IP packet information, whether the link release condition is satisfied. When the link release condition is satisfied, the UE performs the link release procedure for releasing the link early, and when the link release condition is not satisfied, the UE does not perform the link release procedure for releasing the link early.

In one embodiment, the link release condition is based on an inactivity timer having a fixed time value.

In one embodiment, the link release condition is based on an inactivity timer having an adaptive time value, wherein the adaptive time value is based on explicit control on a number of transitions between RRC connected and low power states or implicit control on the number of transitions between RRC connected and low power states.

In one embodiment, the adaptive time value is based on implicit control on the number of transitions between RRC connected and low power states, and the adaptive time value is determined based on: an additive procedure where the value of the inactivity timer is increased or decreased in an additive manner; or a multiplicative procedure where the value of the inactivity timer is increased or decreased in a multiplicative manner; or a combination procedure where the value of the inactivity timer is increased in a multiplicative manner and decreased in an additive manner.

In one embodiment, the link release condition is based on an ML procedure.

In one embodiment, the ML procedure comprises a step-based ML procedure that includes: offline training where a ML model is trained on uplink and downlink data activity; and online operation where an inference related to data activity is obtained from the ML model.

In one embodiment, the UE performs a gating procedure that includes a gating condition, wherein the inference related to data activity is obtained from the ML model when the gating condition is satisfied.

In one embodiment, the ML procedure comprises a burst based ML procedure that includes: offline training where a ML model is trained on burst data that includes one or more of time since last burst, duration of a burst, and an amount of data in the burst; and online operation where an inference related to a new burst is obtained from the ML model.

In one embodiment, the received IP packets only include packets of a certain type, and the link release procedure for releasing the link early is performed when a duration of time since a last packet is received or transmitted satisfies a threshold.

The above flowchart illustrates an example method or process that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method performed by a user equipment (UE), the method comprising:
determining whether the UE is in a radio resource control (RRC) connected state;
when the UE is in the RRC connected state, performing a link management procedure that includes (i) a link release condition procedure for determining whether a link release condition is satisfied and (ii) a link release procedure for releasing a link early and reducing UE power consumption; and
when the UE is not in the RRC connected state, not performing the link management procedure.

2. The method of claim 1, wherein performing the link management procedure comprises:
performing the link release condition procedure for determining, based on received internet protocol (IP) packet information, whether the link release condition is satisfied;
when the link release condition is satisfied, performing the link release procedure for releasing the link early; and
when the link release condition is not satisfied, not performing the link release procedure for releasing the link early.

3. The method of claim 2, wherein the link release condition is based on an inactivity timer having a fixed time value.

4. The method of claim 2, wherein the link release condition is based on an inactivity timer having an adaptive time value, wherein the adaptive time value is based on explicit control on a number of transitions between RRC connected and low power states or implicit control on the number of transitions between RRC connected and low power states.

5. The method of claim 4, wherein the adaptive time value is based on implicit control on the number of transitions between RRC connected and low power states, and the adaptive time value is determined based on:
an additive procedure where the value of the inactivity timer is increased or decreased in an additive manner; or
a multiplicative procedure where the value of the inactivity timer is increased or decreased in a multiplicative manner; or
a combination procedure where the value of the inactivity timer is increased in a multiplicative manner and decreased in an additive manner.

6. The method of claim 2, wherein the link release condition is based on a machine learning (ML) procedure.

7. The method of claim 6, wherein the ML procedure comprises a step-based ML procedure that includes:
offline training where a ML model is trained on uplink and downlink data activity; and
online operation where an inference related to data activity is obtained from the ML model.

8. The method of claim 7, wherein the step-based ML procedure further comprises performing a gating procedure that includes a gating condition, wherein the inference related to data activity is obtained from the ML model when the gating condition is satisfied.

9. The method of claim 6, wherein the ML procedure comprises a burst based ML procedure that includes:
offline training where a ML model is trained on burst data that includes one or more of time since last burst, duration of a burst, and an amount of data in the burst; and
online operation where an inference related to a new burst is obtained from the ML model.

10. The method of claim 2, wherein the received IP packets only include packets of a certain type, and the link release procedure for releasing the link early is performed when a duration of time since a last packet is received or transmitted satisfies a threshold.

11. A user equipment (UE) comprising:
a transceiver; and
a processor operably coupled to the transceiver, the processor configured to:
determine whether the UE is in a radio resource control (RRC) connected state;
when the UE is in the RRC connected state, perform a link management procedure that includes (i) a link release condition procedure for determining whether a link release condition is satisfied and (ii) a link release procedure for releasing a link early and reducing UE power consumption; and
when the UE is not in the RRC connected state, not perform the link management procedure.

12. The UE of claim 11, wherein to perform the link management procedure, the processor is configured to:
perform the link release condition procedure for determining, based on received internet protocol (IP) packet information, whether the link release condition is satisfied;
when the link release condition is satisfied, perform the link release procedure for releasing the link early; and
when the link release condition is not satisfied, not perform the link release procedure for releasing the link early.

13. The UE of claim 12, wherein the link release condition is based on an inactivity timer having a fixed time value.

14. The UE of claim 12, wherein the link release condition is based on an inactivity timer having an adaptive time value, wherein the adaptive time value is based on explicit control on a number of transitions between RRC connected and low power states or implicit control on the number of transitions between RRC connected and low power states.

15. The UE of claim 14, wherein the adaptive time value is based on implicit control on the number of transitions between RRC connected and low power states, and the adaptive time value is determined based on:
an additive procedure where the value of the inactivity timer is increased or decreased in an additive manner; or
a multiplicative procedure where the value of the inactivity timer is increased or decreased in a multiplicative manner; or
a combination procedure where the value of the inactivity timer is increased in a multiplicative manner and decreased in an additive manner.

16. The UE of claim 12, wherein the link release condition is based on a machine learning (ML) procedure.

17. The UE of claim 16, wherein the ML procedure comprises a step-based ML procedure that includes:
offline training where a ML model is trained on uplink and downlink data activity; and
online operation where an inference related to data activity is obtained from the ML model.

18. The UE of claim 17, wherein to perform the step-based ML procedure, the processor is configured to perform a gating procedure that includes a gating condition, wherein the inference related to data activity is obtained from the ML model when the gating condition is satisfied.

19. The UE of claim 16, wherein the ML procedure comprises a burst based ML procedure that includes:
offline training where a ML model is trained on burst data that includes one or more of time since last burst, duration of a burst, and an amount of data in the burst; and
online operation where an inference related to a new burst is obtained from the ML model.

20. The UE of claim 12, wherein the received IP packets only include packets of a certain type, and the link release procedure for releasing the link early is performed when a duration of time since a last packet is received or transmitted satisfies a threshold.
